(19) United States
(12) Patent Application Publication
(10) Pub. No.: US 2014/0236616 A1
(43) Pub. Date: Aug. 21, 2014

(54) Method for Managing a Therapeutic Substance Regimen

(71) Applicant: Mango Health Inc., San Francisco, CA (US)

(72) Inventors: Jason Oberfest, San Francisco, CA (US); Gerald Cheong, Los Altos, CA (US)

(73) Assignee: Mango Health Inc., San Francisco, CA (US)

(21) Appl. No.: 14/185,110

(22) Filed: Feb. 20, 2014

Related U.S. Application Data
(60) Provisional application No. 61/865,961, filed on Aug. 14, 2013.
(60) Provisional application No. 61/766,806, filed on Feb. 20, 2013.

(51) Int. Cl. G06Q 50/22; G06Q 10/00

(52) U.S. Cl. CPC G06Q 50/22; G06Q 10/00
USPC 705/2

(57) ABSTRACT

A method and system for managing a therapeutic substance regimen including: receiving therapeutic substance information from a user; receiving information regarding a regimen; providing interaction information based on the therapeutic substance information; receiving an ascertainment of adherence to the regimen at a set of time points; generating an adherence metric based upon the ascertainment and the set of time points; providing a reward to the user based on the adherence metric; and providing an automated notification to the user based upon at least one of the ascertainment, the adherence metric, and the reward. The method can further comprise providing an advertisement to the user based on one of the therapeutic substance information and the regimen, generating a comparison of the adherence metric for the user to the adherence metric for a second user, and generating an automated refill or renewal request based upon the therapeutic substance information and the regimen.

### CROSS-REFERENCE TO RELATED APPLICATIONS

This application claims the benefit of U.S. Provisional Application Ser. No. 61/766,806, filed on 20 Feb. 2013 and U.S. Provisional Application Ser. No. 61/865,961 filed on 14 Aug. 2013, which are both incorporated herein in their entirety by this reference.

### TECHNICAL FIELD

This invention relates generally to the health care field, and more specifically to a new and useful method for managing a medication regimen.

### BACKGROUND

The number of people taking prescription and over-the-counter (OTC) medications and supplements is significantly rising, and problems associated with this rise include non-adherence to a regimen and management of drug/supplement interactions. Non-adherence alone costs the U.S. hundreds of billions of dollars each year; however, methods of targeting non-adherence have primarily focused on physiological tracking of medication usage at the patient level, and analysis of medication adherence at the administrative level. These methods of targeting non-adherence have been largely ineffective at promoting adherence to a regimen, and require additional significant financial and time expenditures. Management of drug/supplement interactions is also typically limited by the experience of health care professionals interacting with patients, and/or involves reliance upon electronic databases that are user-unfriendly. Furthermore, additional issues associated with the rising number of people taking medications and supplements have not been effectively addressed, and ways of utilizing and sharing data from people taking medications and supplements have not been effectively implemented.

There is thus a need in the health care field to create a new and useful method for managing a therapeutic substance regimen. This invention provides such a new and useful method.

### BRIEF DESCRIPTION OF THE FIGURES

FIG. 1 depicts a flowchart of an embodiment of a method for managing a therapeutic substance regimen;

FIG. 2 depicts a flowchart of one variation of receiving medication and/or supplement information from a user;

FIG. 3A depicts a specific example of a user interface implementing an embodiment of the method;

FIG. 3B depicts another variation of receiving medication and/or supplement information from a user;

FIGS. 3C and 3D depict specific examples of receiving medication and/or supplement information, and verifying medication and/or supplement information, respectively;

FIGS. 3E and 4 depict examples of providing information at a user interface;

FIG. 5 depicts an example of ascertaining the user's adherence to the regimen at a user interface;

FIG. 6A depicts an example of generating a value of an adherence metric, and providing a reward to the user based on the value of the adherence metric, respectively;

FIGS. 6B, 6C, and 7 depict examples of providing a notification to the user;

FIG. 8 shows an example of generating a comparison of the value of the adherence metric for the user to a second value of the adherence metric generated based upon information for at least a second user, or comparison to an overall population of users taking the same medication, users with the same condition, or based on other aggregate comparisons to others in the end user community;

FIG. 9 depicts a flowchart of one variation of generating a comparison of the adherence metric for the user to the adherence metric for a second user;

FIGS. 10A-10C depict variations of the method;

FIG. 11 depicts a flowchart of an embodiment of a method for enrolling and mapping users;

FIG. 12 depicts a schematic of an embodiment of a method for enrolling and mapping users;

FIGS. 13A-13C depict schematics of portions of an embodiment of a method for enrolling and mapping users;

FIG. 14 depicts a portion of an embodiment of a method for enrolling and mapping users;

FIG. 15 shows an embodiment of a system for managing a therapeutic substance regimen; and

FIG. 16 shows an embodiment of a system for enrolling and mapping users.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Method

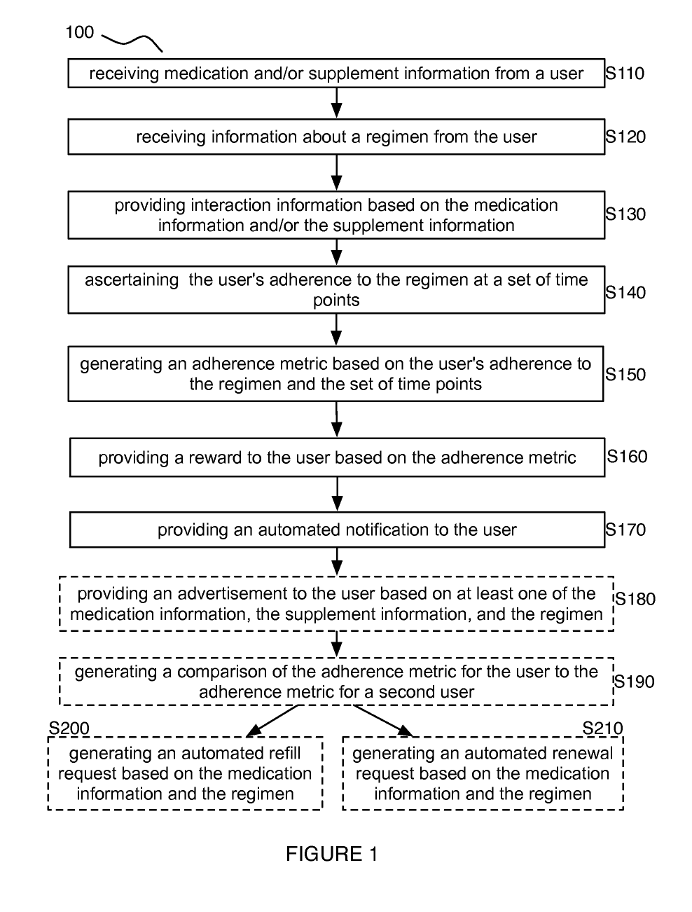

As shown in FIG. 1, an embodiment of a method 100 for managing a therapeutic substance regimen comprises receiving therapeutic substance information from a user S110; receiving information about a regimen from the user S120; providing interaction information based on the therapeutic substance information S130; receiving an ascertainment of adherence to the regimen by the user at a set of time points S140; generating a value of an adherence metric based upon the ascertainment and the set of time points S150; providing a reward to the user based on the value of the adherence metric S160; and providing an automated notification to the user based upon at least one of the ascertainment, the adherence metric, and the reward S170. The method 100 may further comprise providing an advertisement to the user based on at least one of the therapeutic substance information and the regimen S180, generating a comparison of the value of the adherence metric for the user to a second value of the adherence metric determined based upon data for at least a second user S190, generating an automated refill request based upon the therapeutic substance information and the regimen S200, and generating an automated renewal request based on the therapeutic substance information and the regimen S210.

The method 100 is preferably implemented through an application on a mobile device comprising or coupled to a storage module (e.g., server, cloud, hardware storage), an imaging module (e.g., an optical sensor with image processing software), a user interface, and/or a message client. The method 100 can also implement a communication connection to at least one social network. The method 100 may alternatively or additionally be implemented by any suitable computing device. A user may provide credentials for the at least one social network to obtain more personalized and relevant content, but a user is preferably able a use a system implementing the method 100 without being signed into a social network, and/or without being a member of a social network.

The method 100 can be used to facilitate behavior change in adhering to a therapeutic substance regimen (e.g., medication regimen), can educate users regarding medication and supplement interactions, and/or can provide a medium to facilitate targeted advertising to users based on therapeutic substance (e.g., medication, supplement) usage. The method 100 can further prevent overdosing on medications and/or supplements by a user. In some embodiments, the method 100 can enable generation of comparisons between user-reported adherence profiles (e.g., determined at an application implementing the method) and adherence profiles observed by a therapeutic substance provider (e.g., by analyzing medication refill parameters, by analyzing a medication possession ratio, by analyzing a proportion of days covered, etc.). Such comparisons in adherence profiles can be generated for one or more users, for one or more therapeutic substances, and/or for one or more substance classifications (e.g., statins, ACE inhibitors). The method 100 is preferably used to facilitate behavior change by human users taking therapeutic substance, but can alternatively be used to facilitate behavior change by caretakers (e.g., owners of pets, animal caretakers, caretakers of incapacitated patients) managing a therapeutic substance regimen for another entity. Additionally, various combinations of steps of the method 100 can be used for specific applications related to managing a therapeutic substance regimen, and three specific variations of the method 100 with three different applications are described in Sections 1.1-1.3.

### 1.1 Method—Receiving Therapeutic Substance Information

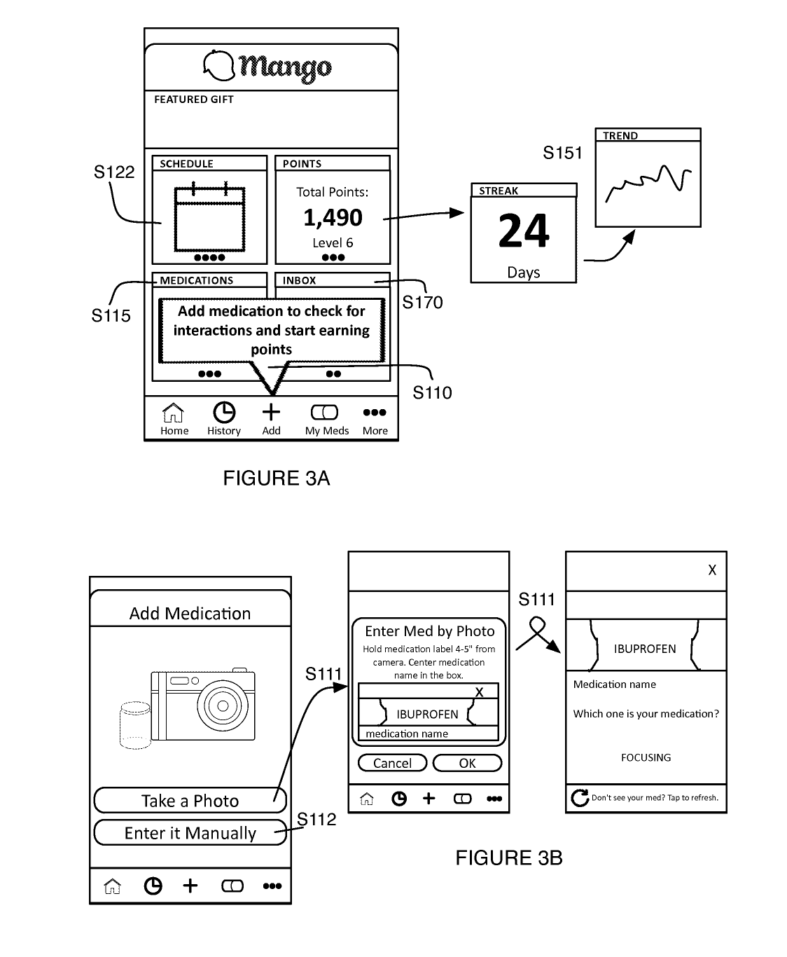

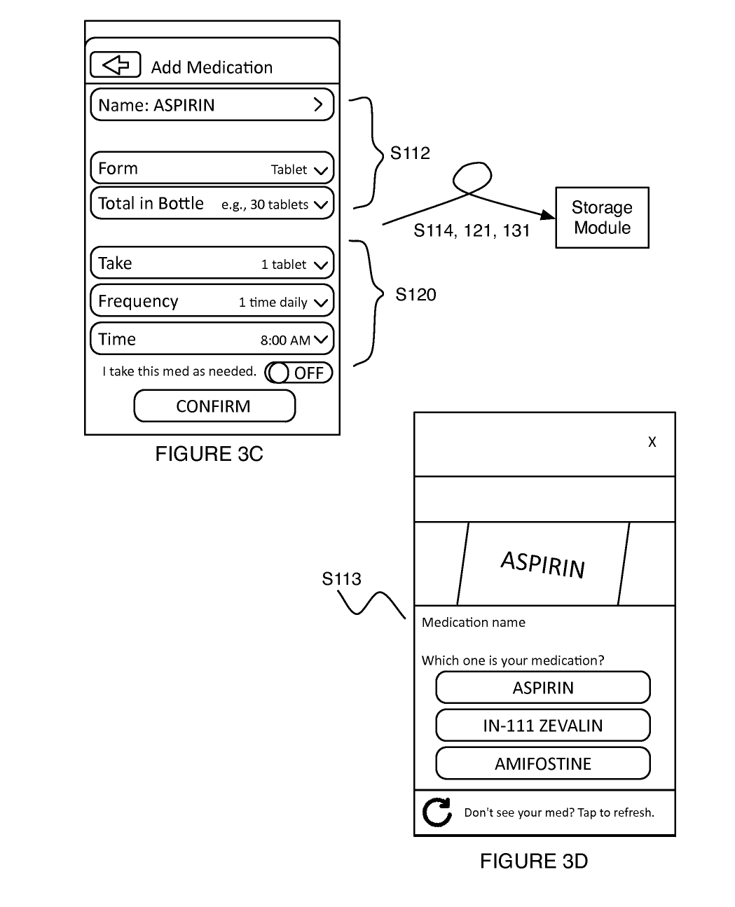

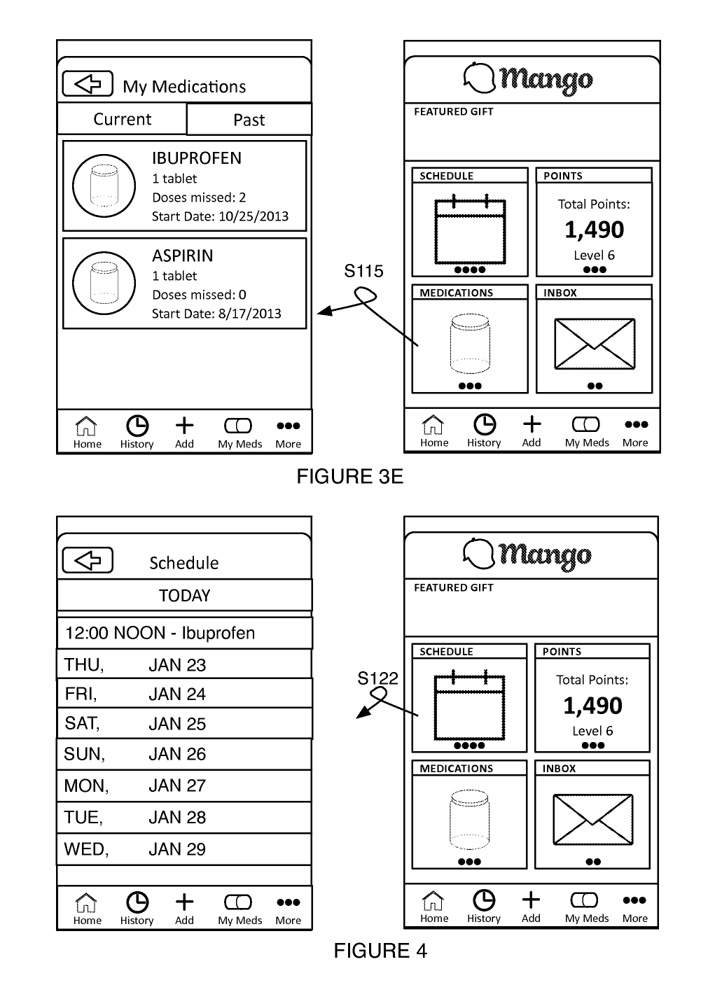

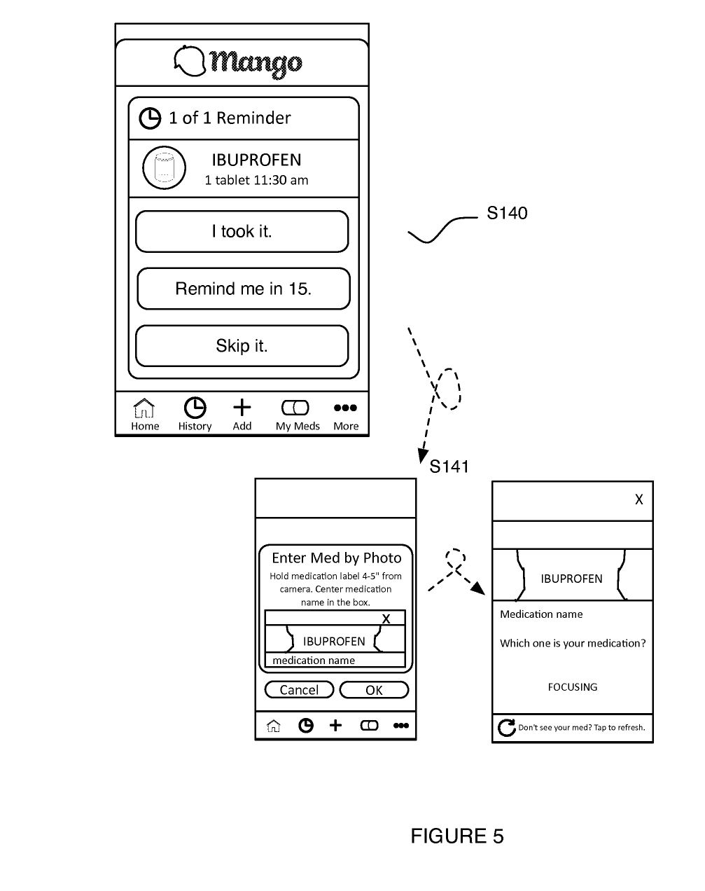

Block S110 recites receiving therapeutic substance information from a user, and functions to facilitate determination of therapeutic substance interaction information and to prevent fraudulent activity. The therapeutic substance information can include medication information and/or supplement information for one or more of a set of therapeutic substances. In variations, the medication information can comprise medication name, and can further comprise information including one or more of: generic name(s), brand name(s), active ingredient(s), strength (e.g., active ingredient amount per unit), category (e.g., prescription or OTC), use (e.g., pain killer, antidepressant, birth control), form (e.g., tablet, capsule, liquid, color, odor), quantity (e.g., current quantity, unopened quantity, number, volume), expiration date, and medication provider information (e.g., pharmacy contact information). In variations, the supplement information can comprise supplement name, and can further comprise information including one or more of: alternative name(s), active ingredient(s), strength, use, form, quantity, and expiration date. In one example, an application on a mobile device implementing the method 100 is configured to receive medication and/or supplement name, form, and quantity, as shown in FIG. 3A. Other variations of Block S110 may comprise receiving any appropriate combination of the information types described above, and/or additional information types. Additionally, Block S110 may further comprise receiving information for multiple medications and/or supplements from the user.

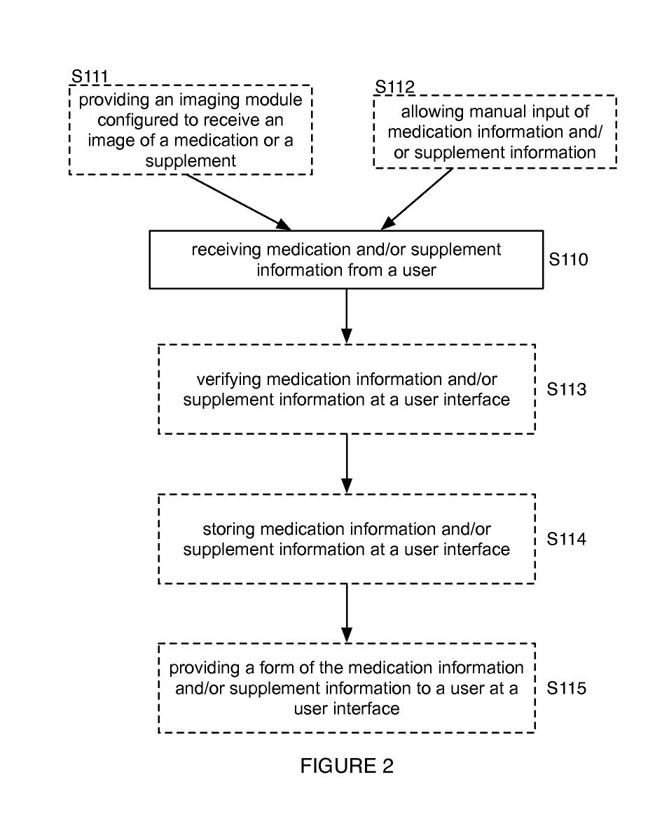

Block S110 can include providing an imaging module configured to receive an image of at least one of a set of therapeutic substances (e.g., of a medication or a supplement) S111, as shown in FIG. 2, wherein the imaging module is able to abstract medication information and/or supplement information from the image. Block S111 functions to facilitate reception of medication therapeutic substance information by minimizing user input (e.g., minimizing use a keypad on a mobile device), and further functions to prevent fraudulent activity by providing verification that a user is actually in possession of and is taking the therapeutic substance. As shown in FIG. 3B, an example of an implementation of Block S111 may include providing an imaging module accompanied by imaging instructions (e.g., position relative to a mobile device camera), and comprising automatic focusing of the image to facilitate acquisition of the image. In the example implementation of Block S111, the imaging module is able to detect text within the image related to the medication information and/or supplement information described above, using image processing and text detection software. However, other variations of Block S111 can omit providing imaging instructions and/or an imaging module comprising automatic focusing. Additionally, other variations of Block S111 may further comprise providing an imaging module configured to abstract medication information and/or supplement information based on an image of a form of the medication and/or supplement (e.g., not an image of a label, but an image of a tablet, capsule or liquid) by way of an image processing algorithm.

Block S110 can additionally include allowing manual input of therapeutic substance information at a user interface S112, as shown in FIGS. 2 and 3C. In one example, Block S112 includes allowing manual input of therapeutic substance information using a keypad coupled to a user interface of a mobile device or computing device implementing the method 100. In another example, Block S112 includes allowing manual input of therapeutic substance information by speaking into a sound receiver (e.g., microphone) of a mobile device or computing device implementing a portion of the method 100, wherein a speech detection algorithm facilitates processing of therapeutic substance information. Block S112 can, however, additionally or alternatively use any other suitable variation of manual input of information.

In some variations, Block S110 can further include verifying therapeutic substance information at a user interface S113, as shown in FIG. 2. Block S113 thus functions to enable verification of the accuracy of medication information and/or supplement information. Preferably, Block S113 comprises presenting a name of at least one potential therapeutic substance option to a user in response to therapeutic substance information received in Block S110. The at least one potential medication and/or supplement option is preferably retrieved from a storage module comprising or configured to access a database of medication and supplements (e.g., a database of U.S. Food and Drug Administration approved medications and nutritional supplements), but may alternatively be derived from another source. Block S113 may further comprise allowing a user to search a database to verify therapeutic substance information, and/or allowing a user to refresh presented potential medication/supplement options at a user interface. Block S113 may additionally or alternatively comprise presenting at least one image of a potential medication and/or supplement option to a user at a user interface, in order to facilitate verification of the option by the user or another entity. An example implementation of Block S113, as shown in FIG. 3D, comprises presenting a list of names of potential medications retrieved from a storage module containing a database, allowing a user to refresh the list of names of potential medications, and allowing a user to select a medication to verify medication information.

In some variations, Block S110 can further comprise storing the medication information and/or the supplement information at a storage module S114, which functions to enable reception, storage, and/or transmission of therapeutic substance information for at least one user. Preferably, storing information at a storage module comprises storing information on at least one of a server (e.g., remote or local server), a cloud, or a hardware storage module; however, storing information at a storage module can additionally or alternatively comprise any appropriate method of storing therapeutic substance information, such that information may be retrieved and transmitted in some form.

Block S110 can also comprise providing a form of the therapeutic substance information to a user at a user interface S115, which functions to provide a an information resource summarizing therapeutic substances (e.g., medications, supplements) the user is taking. Block S115 can include accessing and retrieving medication information and/or supplement information at a storage module, and displaying the information at a user interface. An example implementation of Step 115, as shown in FIG. 3E, comprises providing a list of names of medications and/or supplements the user is taking at a user interface of an application executing on a mobile device. The list in the example is further configured to link to more medication information and/or supplement information, which is configured to be displayed at the user interface upon selecting a name of the list of names. In variations, Block S115 can additionally or alternatively include any other suitable variation of providing a form of the medication information and/or supplement information to a user or other entity.

Block S120 recites receiving information about a regimen from the user, and functions to enable verification of adherence to the regimen, and generation of an adherence metric based on user adherence to the regimen. The information about a regimen preferably comprises user instructions for taking at least one medication and/or supplement, including dosage instructions (e.g., quantity or volume), frequency instructions (e.g., daily, every other day, twice a day, as needed), time instructions (e.g., morning, midday, evening), and/or other instructions (e.g., after a meal, on empty stomach, with a glass of liquid). The information about the regimen may further comprise information related to potential medication and/or supplement usage risks. For example, some low-risk medications and supplements have no associated usage risks and can be taken at any time during the day. Furthermore, missing or doubling doses of these low-risk medications and supplements does not generate any substantial user risk. Other medications, however, are high-risk and should either never be taken at a double dosage level in the event of a missed dosage (e.g., anxiety medication), or should be taken at a double dosage level in the event of a missed dosage (e.g., antibiotic). Thus, receiving information about a regimen may further include receiving potential medication and/or supplement usage risks, including those described above and any other suitable medication and/or supplement usage risks.

Receiving information about the regimen preferably comprises receiving information manually input by a user (e.g., by using a keypad coupled to a user interface or by using a microphone); however, receiving information about the regimen can additionally or alternatively comprise providing an imaging module configured to receive an image of an object displaying text related to the regimen (e.g., prescription, medication package) and configured to extract regimen information from the image using text and image processing software. In other variations, Block S120 may comprise any appropriate method of receiving information. An example implementation of Block S120 is performed by an application executing on a mobile device, as shown in FIG. 3C, wherein the application facilitates reception of medication dosage instructions, frequency instructions, and time instructions manually by user input.

In variations, Block S120 can further comprise storing information about the regimen on a storage module S121, which functions to enable reception, storage, and/or transmission of information about a regimen for at least one user. Preferably, storing information at a storage module comprises storing information on at least one of a server (e.g., remote or local server), a cloud, or a hardware storage module as in Block S114; however, storing information at a storage module can additionally or alternatively comprise any appropriate method of storing regimen information, such that information may be retrieved and transmitted in some form.

In variations, Block S120 can also comprise providing a report derived from the regimen to a user at a user interface S122, which functions to provide a resource to the user to facilitate the user's adherence to the regimen. Block S122 may include accessing and retrieving information about the regimen at a storage module and processing information about the regimen to generate the report derived from the regimen at a user interface. In one variation, the report of the regimen can comprise a visual representation of the regimen including a medication and/or supplement-taking schedule (e.g., with dosages, instructions, and time of day for therapeutic substance usage). In an example implementation of Step 122, as shown in FIG. 4, providing a report of the regimen to a user comprises providing a calendar and a schedule to the user at a user interface, wherein the calendar is be configured to display time increments (e.g., days, weeks, months) that can be adjusted by the user, and is integrated with a schedule for taking one or more medications according to the regimen. Upon selecting a time increment/time point of the calendar at the user interface, the user is provided with time point/increment-specific details of his/her regimen.

### 1.2 Method—Promoting User Adherence

Block S130 recites providing interaction information based on the therapeutic substance information, and functions to educate a user or other entity with regard to possible interactions between medications and/or supplements the user is taking. Preferably, the interaction information includes potentially dangerous interactions between medications and/or supplements included in the regimen of the user, such that the user is informed of potential adverse effects of combining specific medications and/or supplements. Additionally, the interaction information may include effects of taking interacting medications and/or supplements, such that the user is informed of consequences of taking certain medications and/or supplements in combination or in sequence. Preferably, the interaction information is retrieved from a storage module comprising a database of known interactions between medications and supplements. In one variation, providing interaction information automatically occurs when therapeutic substance information for medications and/or supplements with known interactions is received at Block S110. In this variation, receiving information for a second medication or supplement that has a known interaction with a first medication or supplement can trigger access (e.g. by an application executing on a mobile device) of a database of known interactions, and information from the database can be automatically provided to the user (e.g., at a user interface of the application). In an embodiment of the method comprising Block S115, a form of the medication information provided at Block S115 can further comprise interaction information related to the user's medications and/or supplements. In another variation, Block S130 can further comprise providing a list of all medications and/or supplements potentially interacting with the user's medications and/or supplements. In this other variation, a user can thus be able to preemptively avoid medications and/or supplements known to interact with the user's medications and/or supplements. Furthermore, a user equipped with this information can be prepared to use or suggest alternative therapeutic substances in the event the user is prescribed with a medication or supplement that could interact with current therapeutic substances the user is taking.

In variations, Block S130 can further comprise storing interaction information at a storage module S131, which functions to enable reception, storage, and/or transmission of interaction information for at least one user. Preferably, storing information at a storage module comprises storing information on at least one of a server (e.g., remote or local server), a cloud, or a hardware storage module as in Blocks S114 and/or S121; however, storing information at a storage module can additionally or alternatively comprise any appropriate method of storing regimen information, such that information may be retrieved and transmitted in some form.

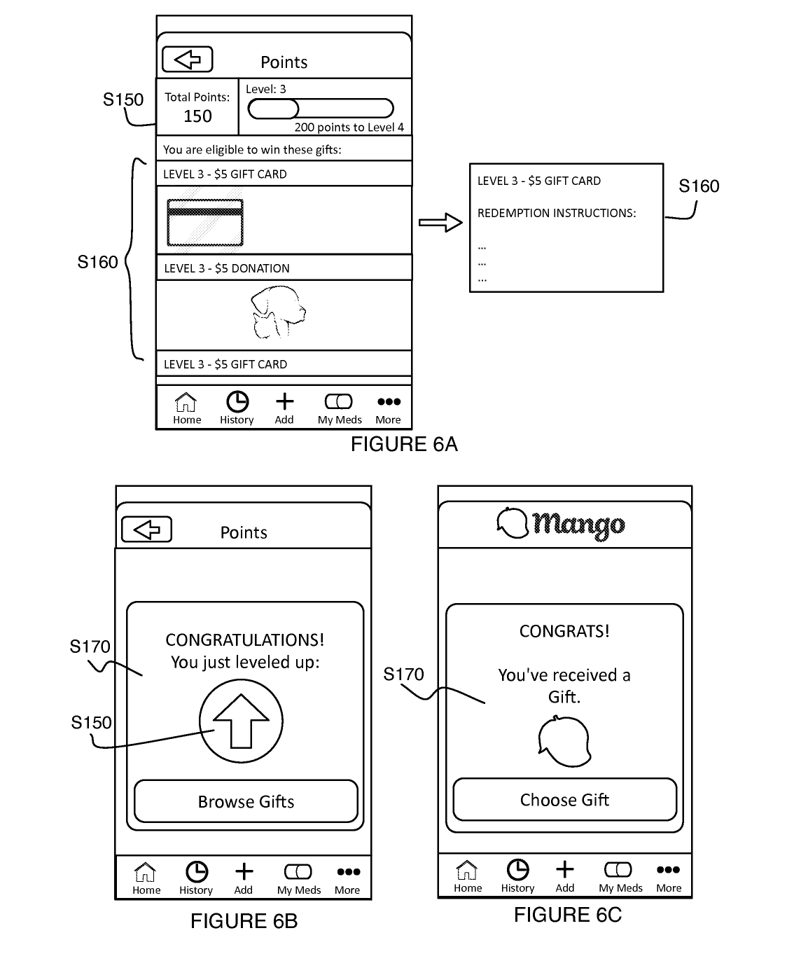

Block S140 recites receiving an ascertainment of adherence to the regimen by the user at a set of time points, and functions to provide data for generation of an adherence metric. Block S140 can also function to prevent fraudulent activity. Preferably, Block S140 includes allowing a user to ascertain his/her own adherence to the regimen at a user interface and receiving ascertainment by way of signals generated at the user interface; however, ascertainment of a user's adherence to the regimen may alternatively be performed by another entity and/or received in any other suitable manner. Additionally, the set of time points can comprise regular time intervals (e.g., days or weeks), or can additionally or alternatively comprise time points corresponding to relevant time points of the regimen received Block S120. In a specific example, as shown in FIG. 5, Block S140 comprises prompting a user to ascertain adherence to the regimen at a user interface of an application executing on a mobile device, such that the user is able to indicate that 1) he or she has adhered to the regimen, 2) he or she should be reminded at another time to follow the regimen, or 3) he or she desires to skip an aspect of the regimen. In the specific example, the user interface provides a summary of a relevant aspect of the regimen, including the name of the medication (e.g., fish oil), the dosage information of the medication (e.g., 1 capsule), and the time information (e.g. 11:15 AM) for the regimen. In the specific example, the prompt can be followed by a reminder, such that the user is reminded to respond to the prompt for ascertainment. Furthermore, ignoring the prompt and/or the reminder constitutes an ascertainment of non-adherence to the regimen for the prompted therapeutic substance(s). Similar to the above blocks, information related to the user's adherence to the regimen can be stored, retrieved, and transmitted at a storage module, in order to facilitate generation of an adherence metric for the user. The information related to the user's adherence can be simple binary information (e.g., ‘yes’ for adherence and ‘no’ for non-adherence) at each time point of the set of time points, or can comprise a scale of adherence at each time point of the set of time points. In an example, the information related to the user's adherence indicates 75% adherence if the user has properly taken three out of four medications of his or her regimen at a given time point/time window. In another example, the information related to the user's adherence indicates non-adherence if the user has improperly taken one out of four medications of his or her regimen at a given time point/time window.

Similar to Block S110, Block S140 can include providing an imaging module configured to receive an image of a medication or a supplement being taken by the user S141, wherein the imaging module is able to abstract medication information and/or supplement information from the image (e.g., an image dataset) to ascertain if the user has adhered to the regimen. Block S141 thus functions to facilitate ascertainment of user adherence to the regimen and further functions to prevent fraudulent activity by providing verification that a user is actually in possession of and is taking the therapeutic substance(s) according to the regimen.

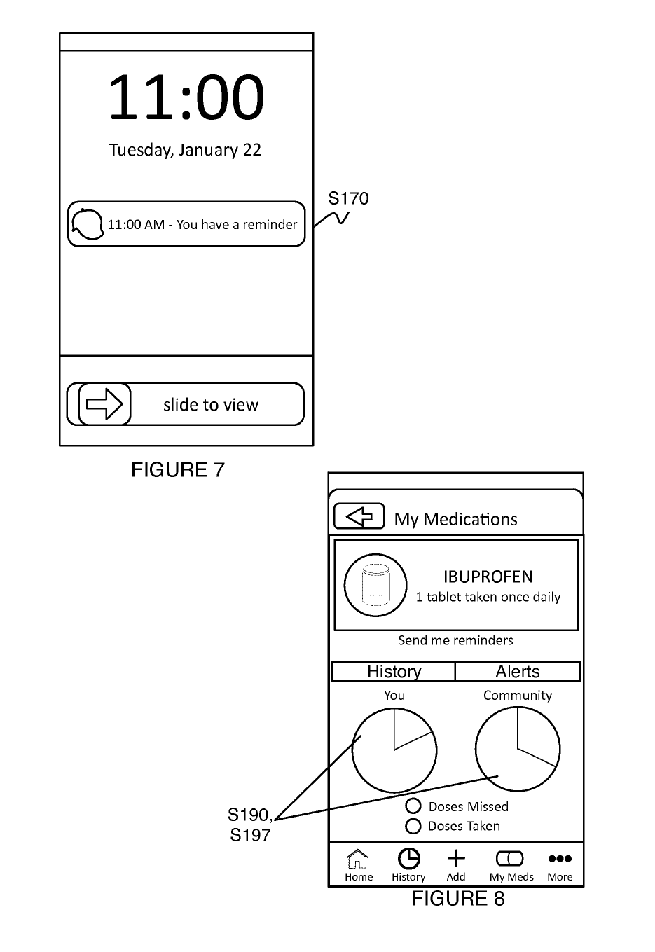

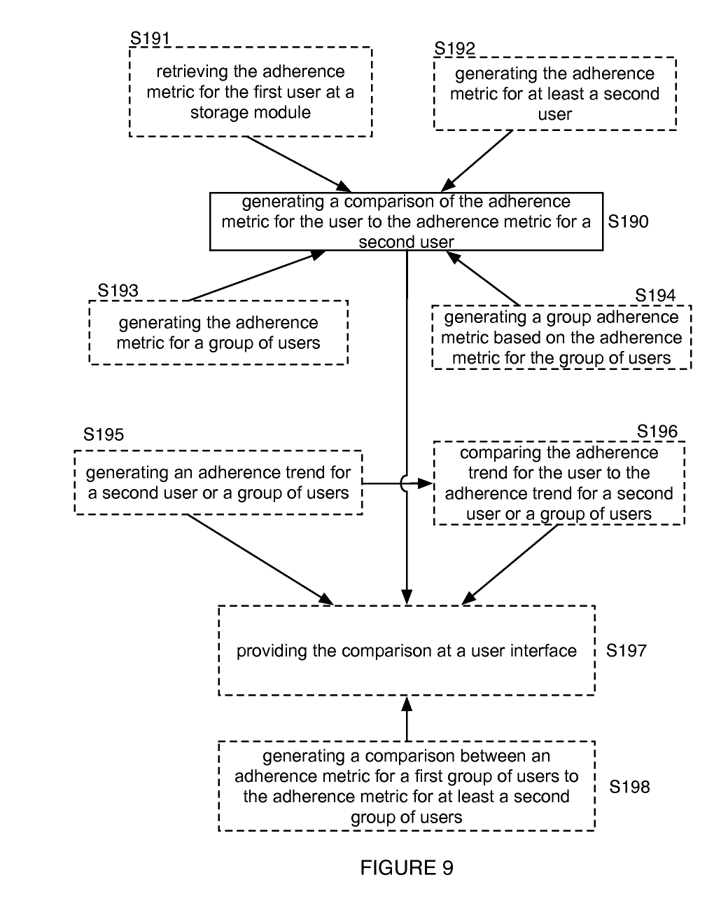

Block S150 recites generating a value of an adherence metric based on the ascertainment of adherence to the regimen and the set of time points, and functions to provide a metric in order to facilitate behavior change by the user, with regard to adhering to the regimen. Block S150 can also function to provide a metric for social comparisons, in order to facilitate behavior change by the user. The adherence metric preferably provides a quantitative metric characterizing the user's adherence over the set of time points, but can additionally or alternatively be a qualitative metric. Preferably, the adherence metric is generated upon retrieval of information related to the user's adherence from a storage module; however, the adherence metric can additionally or alternatively be generated in any other appropriate manner. In some variations, generating the value of the adherence metric includes generating a first quantity characterizing correct adherence to the therapeutic substance regimen by the user, a second quantity characterizing incorrect adherence to the therapeutic substance regimen by the user, and a derivative value based upon the first quantity and the second quantity. The derivative value can be a ratio of incorrect adherence to correct adherence, a comparison between incorrect adherence to correct adherence, a characterization of incorrect adherence to a goal value (e.g., 100% adherence), a characterization of correct adherence to a goal value (e.g., 100% adherence), or any other suitable derivate value. In a first specific example, the adherence metric is an integer number of time points (e.g., days) that the user has properly adhered to the regimen, wherein the integer number of time points corresponds to a number of points that the user has earned. In the first specific example, as shown in FIG. 6A, each day that the user adheres to the regimen corresponds to ten points that the user has earned. Points earned in the first example are used to qualify the user for certain rewards, as described in Block S160, and to allow the user to attain to different levels of adherence, as shown in FIGS. 6A and 6B. In a second specific example, the adherence metric comprises a number of consecutive time points (e.g., days) that the user has adhered to the regimen, such that an adherence “streak” is generated. In a third specific example, the adherence metric comprises a percentage level at which the user has adhered to the regimen over a given number of time points. In the third specific example, the percentage level may indicate 50% for a user who has adhered to the regimen for 15 days out of a 30-day time interval. In a fourth specific example, the adherence metric comprises an adherence trend. In the fourth specific example, the adherence trend indicates the number of days of adherence for each month of a set of months, or may indicate the number of medication/supplement doses missed or doses taken. Block S150 can comprise providing multiple adherence metrics comprising one or more of the above described adherence metrics and trends, and/or additional adherence metrics for measuring adherence to the regimen.

In variations, Block S150 can further comprise providing a form of the value of the adherence metric to the user S151. In an example, Block S151 can comprise rendering an image of the adherence metric (e.g., total number of points earned, total days of adherence, the number of days in the user's adherence “streak”) at a user interface of an application executing on a mobile device, as shown in FIG. 3A. In variations including generation of an adherence trend, a graph of the adherence trend can also be rendered at a user interface. Similar to the above steps, Block S150 can further comprise storing the adherence metric or a derivation of the adherence metric for at least one user at a storage module S152, such that the adherence metric or derivation of the adherence metric can be retrieved and/or transmitted.

Block S160 recites providing a reward to the user based upon the value of the adherence metric, and functions to provide positive reinforcement of user adherence to the regimen. Preferably, the user is qualified for a reward once the value of the adherence metric for the user passes a specified threshold; however, the user can additionally or alternatively be provided with a reward randomly upon any given incidence of adherence to the regimen. In other variations, the user can be provided with a reward upon each incidence of adherence to the regimen, or may not be provided with any reward, such that Block S160 is altogether omitted from the method 100. The reward preferably has monetary value; however, the reward may alternatively have no monetary value. In a first example, as shown in FIG. 6A providing a reward to the user based upon the value of the adherence metric comprises entering the user into a weekly randomized drawing for a reward having monetary value once the user's value of the adherence metric surpasses a certain threshold. In the first example, the reward having monetary value is either a gift card usable at a selection of vendors, or a donation to one of a selection of charities. In the first example, the value of the adherence metric is compared to a set of increasing thresholds, such that the user is qualified for and/or provided rewards of greater value once the user's value of the adherence metric surpasses each successive threshold in the set of increasing thresholds. In a second example, providing a reward to the user based upon the value of the adherence metric comprises providing a coupon or discount to the user based on the value of the adherence metric or upon any given incidence of adherence to the regimen. Block S160 thus encompasses providing a reward of any value to a user and providing a reward at any frequency to the user based on the value of the adherence metric. In addition to providing a reward to the user, Block S160 can further comprise providing a punishment to the user based upon the value of the adherence metric S161, which functions to provide negative reinforcement of user adherence to the regimen.

Block S170 recites providing an automated notification to the user, and functions to provide an alert, recommendation, and/or notification to the user regarding an aspect of at least one of the regimen, the interaction information, the adherence metric, and the reward. With regard to the regimen, the notification may be an alert directing the user to adhere to an aspect of the regimen (e.g., a reminder to take a medication at a specified time), as shown in FIG. 7. With regard to the regimen and potential usage risks, the notification can be an alert recommending against taking a double dosage (e.g., in the event of a missed dosage), or an alert to take a double dosage (e.g., in the event of a missed dosage). With regard to the interaction information, the notification can be an alert providing interaction information and/or information about interaction effects related to the user's mediations and/or supplements, or the notification can be an alert recommending the user to stop taking a medication and/or supplement due to a potential harmful interaction. With regard to the adherence metric, the notification can be an alert notifying the user of an increase, a decrease, or a maintained state in the adherence metric, as shown in FIG. 6B. With regard to the reward, the notification can be an alert notifying the user that he/she has received a reward, as shown in FIG. 6C. However, any other suitable notification relevant to the user can be provided at Block S170.

In a first example wherein Step 170 is implemented by an application executing on a mobile device, and wherein the mobile device comprises a time computing element (e.g., a clock), Step 170 may further include providing a notification using the mobile device at specified times. In the first example, the computing element of the mobile device can further be configured to account for changes in time zone (e.g., in the event the user is travelling), such that the regimen and associated notifications are properly adjusted. In a second example wherein Step 170 is implemented by an application executing on a mobile device, and wherein the mobile device comprises a global positioning sensor (GPS) and a time computing element, Step 170 can further include providing a notification to the user based on the user's location and/or time of day. In the second example, a user may be provided with a notification to take a therapeutic substance according to the regimen if the GPS detects that the user has entered a restaurant location, and if the regimen demands that the user take the medication and/or supplement after a meal. In the second example, a user can also be provided with a notification to take a medication and/or a supplement according to the regimen if the GPS detects that the user is home at his/her bedtime, and if the regimen demands that the user take the medication and/or supplement at bedtime. Step 170 can further comprise providing any other suitable notification based on functionalities of any system implementing the method 100.

The notification can be transmitted over a message client configured to generate a notification at a user interface of an application executing on a computing device, via email, via text message, via voicemail, and/or via a social network (e.g., Facebook, Twitter) message. The notification can additionally or alternatively be transmitted using any other suitable method.

As shown in FIG. 1, the method 100 can further comprise Block S180, which recites providing an advertisement to the user based on at least one of the medication information, the supplement information, and the regimen. Block S180 functions to provide advertising tailored to the user based on a health condition or other characteristic of the user. Preferably, Block S180 comprises providing to an advertisement to the user based on medications the user is taking as part of his/her health regimen; however, Block S180 may alternatively comprise providing an advertisement to the user based on medications the user is not taking. In a first example, providing an advertisement to the user based on at least one of the medication information, the supplement information, and the regimen, and comprises providing an offer for low-sugar iced green tea, distributed by a coffee retailer, in response to receiving information related to type-2 diabetes medications and/or supplements. In a second example, providing an advertisement to the user comprises providing an offer for a low cholesterol sandwich, distributed by a deli, in response to receiving information related to blood pressure or cholesterol-regulating medications and/or supplements. In a third example, providing an advertisement to the user comprises providing an offer for low sodium soups, distributed by a packaged foods company, in response to receiving information related to blood pressure-regulating medications and/or supplements. In a fourth example, providing an advertisement to the user comprises providing an offer for personal training sessions at a local gym, in response to receiving information related to medications and/or supplements for heart disease, weight loss, or diabetes.

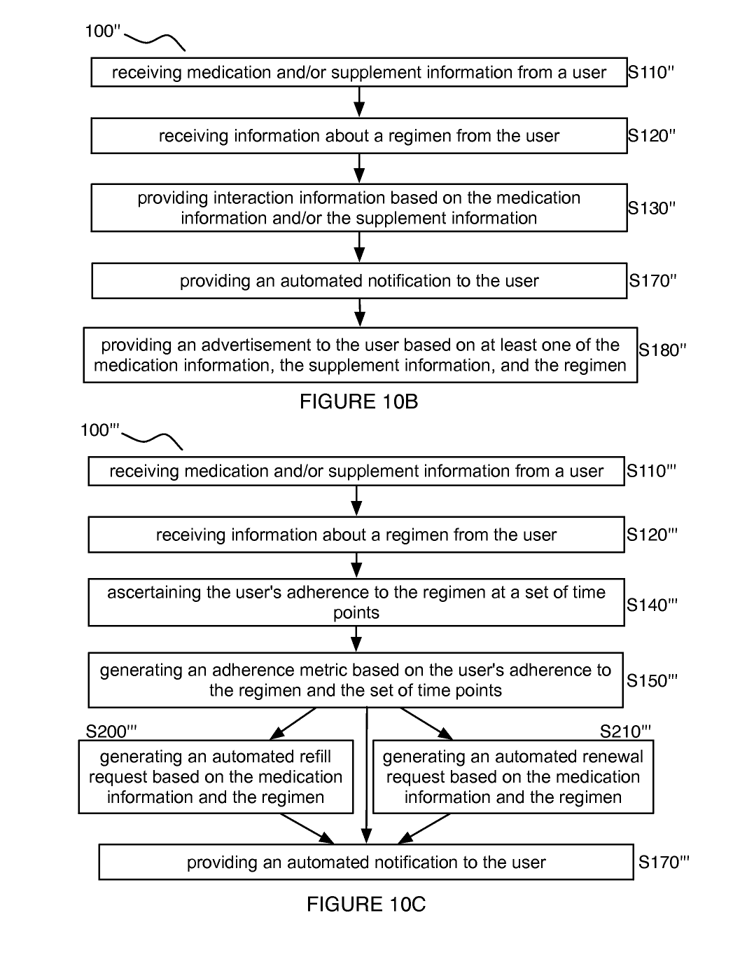

As shown in FIG. 9, the method 100 can also comprise Block S190, which recites generating a comparison of the value of the adherence metric for the user to a second value of the adherence metric determined based upon data for at least a second user. Block S190 functions to provide a social comparison between users following substantially identical, similar, or different regimens, in order to facilitate a behavior change by at least one user. Block S190 preferably comprises retrieving the value of the adherence metric for the first user at a storage module S191, and generating a second value of the adherence metric based upon data for at least a second user S192. Block S190 can further comprise generating an aggregate value of the adherence metric for a group of users S193 and generating a group adherence metric based on the aggregate value of the adherence metric for the group of users S194, such that Block S190 includes comparing the value of the adherence metric for the user to the aggregate value of the adherence metric. In Block S193, the group of users may or may not include the user. In Block S194, generating an aggregate adherence metric can comprise generating an averaged value of the adherence metric across the group of users. In variations of Block S150, wherein generating an adherence metric for the user comprises generating an adherence trend for the user, Block S190 can further include generating an adherence trend for a second user or a group of users S195, and comparing the adherence trend for the user to the adherence trend for a second user or a group of users S196. Additionally, Block S190 can further comprise generating and providing a comparison between a first aggregate value of the adherence metric for a first group of users to a second aggregate value of the adherence metric for at least a second group of users S198, such that groups of users may be compared across at least one adherence metric. Block S198 thus functions to facilitate competitions between groups of users following medication regimens to motivate behavior change and promote adherence. Block S190 may further comprise providing the comparison at a user interface S197, such that a user (or group of users) can directly compare his/her adherence metric to the adherence metric for a user and/or a group of users.

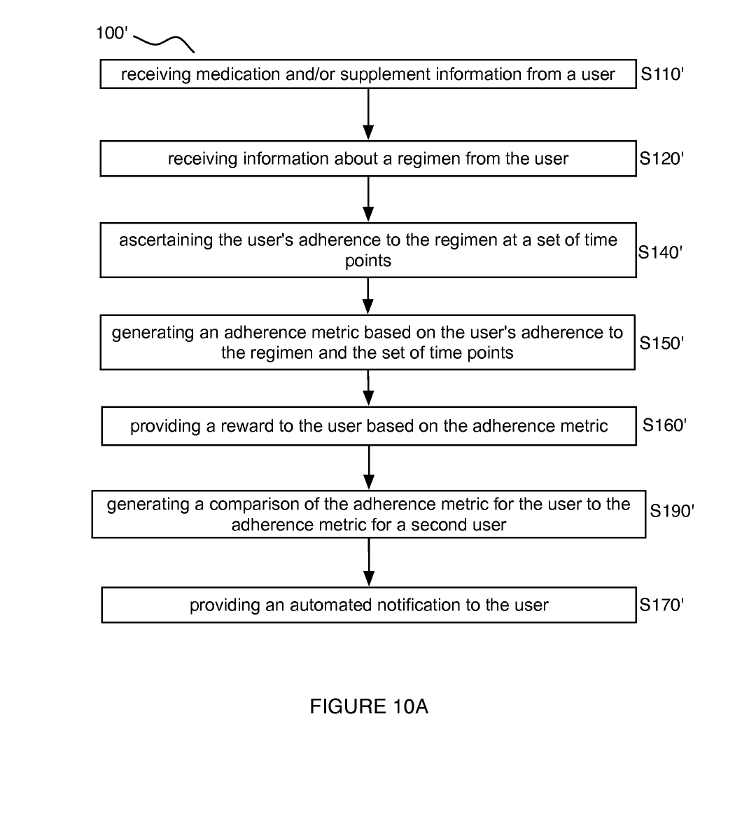

In a first example of Block S190, the total number of days that a user has adhered to his/her regimen can be compared to the total number of days that a second user has adhered to his/her regimen. In a second example of Block S190, the longest adherence “streak” for a user may be compared to the longest adherence “streak” for a second user or for a group of users. In a third example of Block S190, as shown in FIG. 8, an adherence trend indicating the number of medication/supplement doses missed or doses taken for the user (e.g., represented as a pie chart) can be compared to an adherence trend indicating the average number of medication/supplement doses missed or doses taken across a group of users. In a fourth example, patients at a first assisted living community can comprise a first group, and patients at a second assisted living community can comprise a second group, such that at least one adherence metric or adherence trend may be compared between the first and the second group of patients at the assisted living communities. Other variations of Block S190 can comprise generating and/or providing multiple comparisons of adherence metrics for a user or group of users.

As shown in FIG. 1, the method can also comprise Block S200, which recites generating an automated refill request based on the medication information and the regimen. Block S200 functions to notify the user when the medication should be refilled, in order to support adherence to the regimen by the user. Block S200 preferably comprises tracking a remaining amount of the medication and/or supplement, and generating a renewal request automatically when the remaining amount drops below a specified threshold. The threshold can be adjustable (e.g., by the user, by another entity) and can correspond to a set time period before the medication or supplement is expected to run out, such that there is an adequate amount of time between generation of the refill request and refilling of the medication. In one variation, generating an automated refill request based on the medication information and the regimen comprises using the medication form, quantity, dosage information, and frequency information to calculate the remaining amount of the medication, and generating the refill request when the remaining amount of the medication drops below a specific threshold.

In a first example of Block S200, medication information for an original quantity of 30 tablets, and regimen information from a prescription instructing a user to take one tablet every day may be used to set a threshold of 7 tablets, such that a refill request is generated after 23 days into the regimen. In a second example of Block S200, medication information for an original quantity of 250 mL of medication, and regimen information from a prescription instructing a user to take 5 mL twice a day may be used to set a threshold of 50 mL, such that a refill request is generated 5 days before the medication is expected to run out. Other variations of Block S200 may comprise any suitable method of generating a refill request based on any appropriate information. Additionally, other variations of Block S200 can comprise notifying a medication provider of the refill request S201 (e.g., using the application executing on a mobile device), such that the medication provider is automatically notified when the user's medication needs to be refilled.

Also shown in FIG. 1, the method can also comprise Block S210, which recites generating an automated renewal request based on the medication information and the regimen. Block S210 functions to notify the user when the medication should be renewed, in order to support adherence to the regimen by the user. Block S210 is similar to Block S200; however, more time is typically needed to fill medication renewals (as opposed to refills) due to a requirement for authorization by a medical professional servicing the user and/or prescribing the medication. Block S210 preferably comprises tracking a remaining amount of the medication and/or supplement, and generating a renewal request automatically when the remaining amount drops below a specified threshold, wherein the specified threshold is greater than that for generating a refill request. The threshold can be adjustable and can correspond to a set time period before the medication or supplement is expected to run out, such that there is an adequate amount of time between generation of the renewal request and renewing of the medication. In one variation, generating an automated renewal request based on the medication information and the regimen comprises using the medication form, quantity, dosage information, and frequency information to calculate the remaining amount of the medication, and generating the renewal request when the remaining amount of the medication drops below a specific threshold.

In a first example of Block S210, medication information for an original quantity of 30 tablets, and regimen information from a prescription instructing a user to take one tablet every day may be used to set a threshold of 10 tablets, such that a renewal request is generated after 20 days into the regimen. In a second example of Block S210, medication information for an original quantity of 250 mL of medication, and regimen information from a prescription instructing a user to take 5 mL twice a day may be used to set a threshold of 70 mL, such that a renewal request is generated 7 days before the medication is expected to run out. Other variations of Block S210 may comprise any suitable method of generating a renewal request based on any appropriate information. Additionally, other variations of Block S210 may comprise notifying a medication provider of the renewal request S211 (e.g., using the application executing on a mobile device), such that the medication provider is automatically notified when the user's medication needs to be renewed.

The method 100 can, however, include any other suitable Blocks that facilitate user adherence to a therapeutic substance regimen. For instance, variations of the method 100 can include aggregating a record based upon a set of interactions between the user and a native application implementing at least a portion of the method 100, and providing information generated based upon the record to the user, thereby providing the user with a history of his/her behavior. Variations can additionally or alternatively include enabling the user to communicate with at least one other entity (e.g., a peer, a mentor, a caretaker, a healthcare professional, etc.) within the native application or by any other suitable means, for instance, at a message client of a variation of the system 100 described in Section 2 below.

As described earlier, various combinations of steps of the method 100 may be used for specific applications related to managing a medication regimen, and three variations of the method with three different applications are described in Sections 1.3-1.5 below.

### 1.3 Method—Managing a Medication Regimen to Facilitate Behavior Change

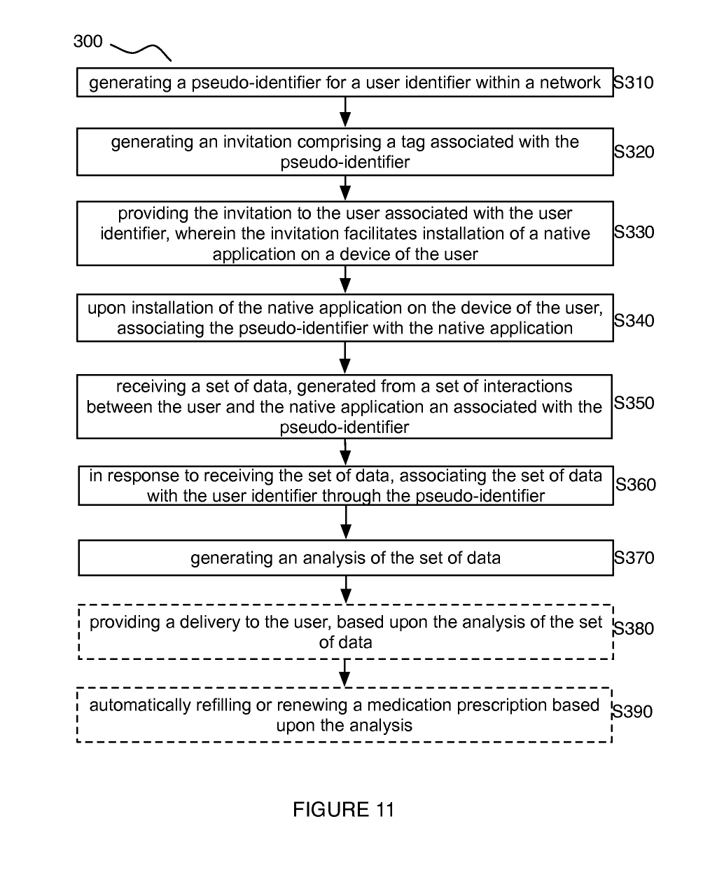

In a first variation of the method 100′, as shown in FIG. 10A, a method for managing a medication regimen to facilitate behavior change can comprise receiving therapeutic substance information from a user S110′; receiving information regarding a therapeutic substance regimen from the user S120′, receiving an ascertainment of the user's adherence to the therapeutic substance regimen at a set of time points S140′, generating a value of an adherence metric based on the ascertainment of adherence to the therapeutic substance regimen and the set of time points S150′, providing a reward to the user based upon the value of the adherence metric S160′; generating a comparison of the value of the adherence metric for the user to a second value of the adherence metric generated from data for at least one other user S190′; and providing an automated notification to the user S170′. The first variation of the method 100′ thus functions to facilitate behavior change in adhering to a medication regimen, such that a user is provided with a reward upon adherence to the medication. Additionally, the first variation of the method 100′ functions to facilitate behavior change by comparing the user's adherence to the regimen to at least one other user's adherence to a regimen, thus motivating at least one user to modify his/her behavior based on a social comparison.

### 1.4 Method—Managing a Personalized Medication Regimen

In a second variation of the method 100″, as shown in FIG. 10B, a method for managing a personalized medication regimen can comprise receiving therapeutic substance information from a user S110″; receiving information regarding a therapeutic substance regimen from the user S110″; providing interaction information based on the therapeutic substance information S130″; providing an automated notification to the user S170″; and providing an advertisement to the user based on at least one of the therapeutic substance information and the therapeutic substance regimen S180″. The second variation of the method 100″ functions to provide a medication regimen tailored to the user, such that the user is educated regarding potential interactions between medications and/or supplements he/she is taking. Additionally, in the second variation of the method 100″, the user is provided with targeted advertising based on a health condition or other characteristic of the user.

1.5 Method—Managing a Medication Regimen with Automated Tracking

In a third variation of the method 100′″, as shown in FIG. 10C, a method for managing a medication regimen with automated tracking can comprise receiving therapeutic substance information from a user S110′″, receiving information regarding a therapeutic substance regimen from the user S110′″; receiving an ascertainment of the user's adherence to the therapeutic substance regimen at a set of time points S140′″; generating an adherence metric based on the ascertainment of adherence to the therapeutic substance regimen and the set of time points S150′″, generating an automated refill request based on the therapeutic substance information and the therapeutic substance regimen S200″, generating an automated renewal request based on the medication information and the therapeutic substance regimen S210′″; and providing a notification to the user S170′″. The third variation of the method 100′″ thus functions to facilitate automatic tracking of a user's adherence to a medication regimen, and to facilitate automatic refill and renewal requests to facilitate adherence to the medication regimen by the user.

Other variations of managing a medication regimen can involve any other suitably combination of the above described method steps.

1.6 Method—Sharing User Data without Sensitive Information Transfer

In one embodiment of the method 100, receiving and/or providing information can be integrated with a provider's system (e.g., a medication provider's system, a therapy provider's system), such that the provider facilitates download of an application facilitating implementation of at least a portion of the method 100 by the user (who receives at least one medication and/or supplement from the provider). As such, embodiments of the method 100 can be facilitated by a method 300 for enrolling and mapping users, in order to enable sharing of information generated from the user(s), without transferring sensitive information (e.g., personal health information). The method 300 for enrolling and mapping users can additionally or alternatively function to provide partners with a flexible integration model with regard to sharing and/or protecting sensitive information from users (e.g., patients).

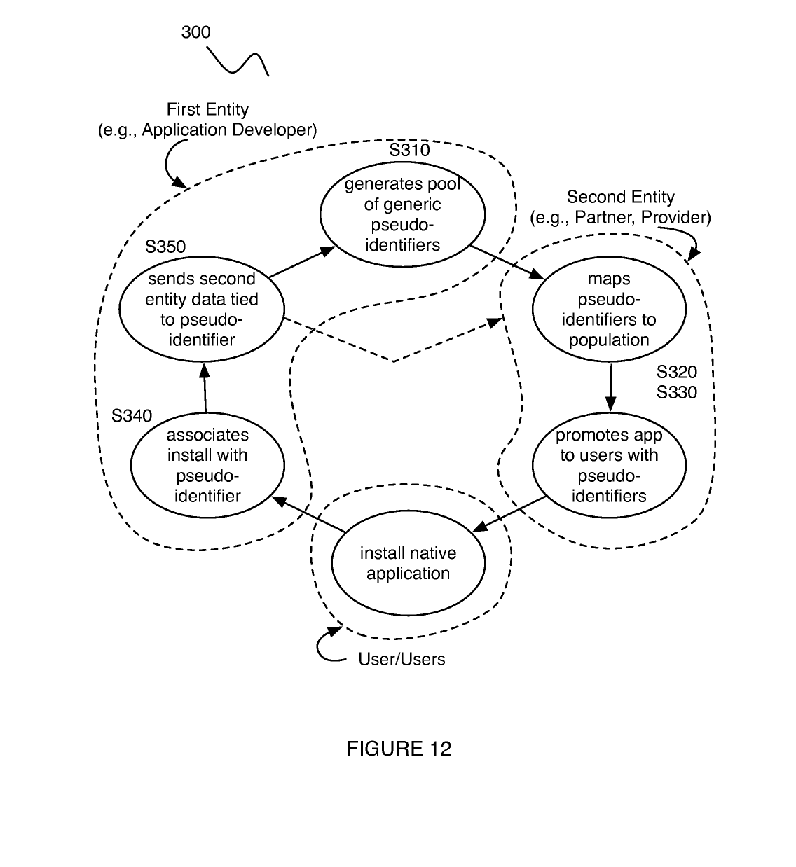

As shown in FIG. 11, an embodiment of a method 300 for enrolling and mapping users comprises: generating a a pseudo-identifier for a user identifier within a network, wherein the user identifier is characterized by an associated set of personal information of a user S310; generating an invitation comprising a tag associated with the pseudo-identifier S320; providing the invitation to the user associated with the user identifier, wherein the invitation facilitates installation of a native application on a device of the user S330; upon verification of the tag provided at the native application on the device of the user, associating the pseudo-identifier with the native application S340; receiving a set of data, generated from a set of interactions between the user and the native application and associated with the pseudo-identifier S350; in response to receiving the set of data, associating the set of data with the user identifier through the pseudo-identifier S360; and generating an analysis of the set of data S370. In some variations, the method 300 for enrolling and mapping users can additionally include providing a delivery to the user, based upon the analysis of the set of data S380.

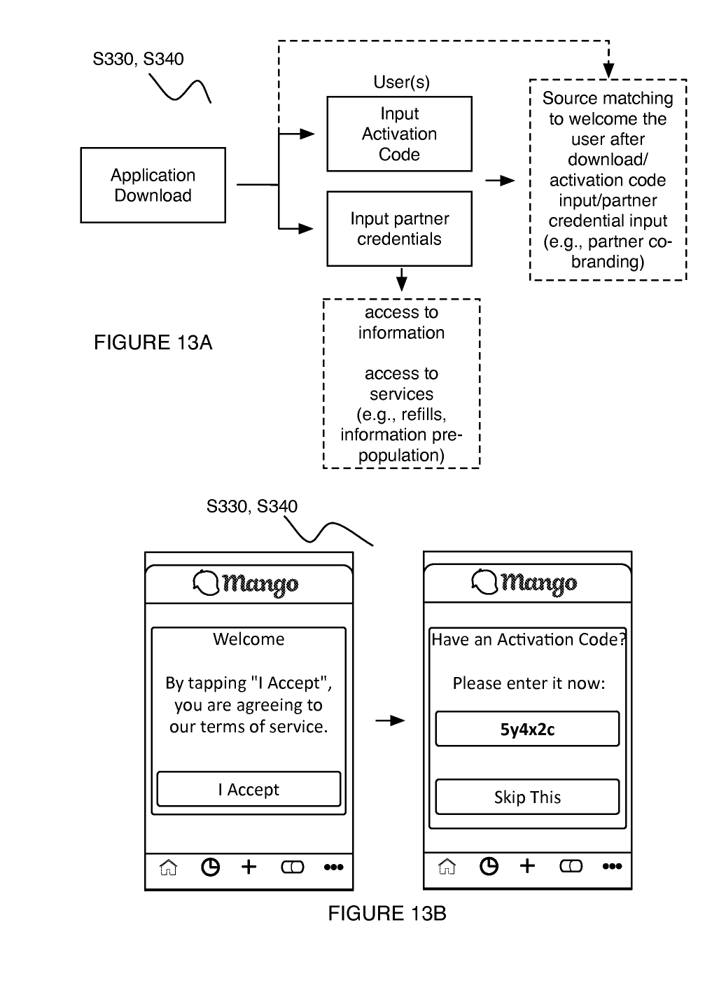

In one variation shown in FIG. 12, the method 100 can be implemented in a manner that facilitates sharing of information between an application developer and a second entity (e.g., a partner with the application developer, a therapeutic substance provider) without transfer of sensitive information, such as protected health information (PHI). The second entity and the application developer can be related by a population of users, each user identified by information subject to information sharing regulations. However, the method 100 can be implemented in a manner that facilitates sharing of information in any other suitable manner. Additionally, the method 100 is preferably implemented, at least in part, through a native application executing on a device including and/or coupled to a storage module (e.g., server, cloud, hardware storage), a user interface, and/or a message client. The method 100 can also be executed in part by using a communication connection to at least one social network. In some variations, a user can provide credentials for the at least one social network to obtain more personalized and relevant content, but a user is preferably able a use a system implementing the method 100 without being signed into a social network, and/or without being a member of a social network.

The method 300 preferably functions to enroll a user or users in an application (e.g., a therapeutic substance regimen monitoring application, a health monitoring application), and to enable sharing of data between entities associated with the user(s) without sharing protected health information. The method 100 can further facilitate behavior change in adherence to a health regimen (e.g., a therapeutic substance regimen), can educate users (e.g., regarding medication and supplement interactions), and can provide a medium to facilitate targeted advertising to users based upon user behavior (e.g., medication and/or supplement usage), without sharing of PHI. The method 100 can further protect a user (e.g., prevent overdosing on medications and/or supplements by a user) by way of data sharing between entities.

Block S310 recites: generating a pseudo-identifier for a user identifier within a network, wherein the user identifier is characterized by an associated set of personal information for a user. Block S110 functions to provide a pseudonymous or abstract identifier for a user, that can be associated with an installation of a native application on a device of the user and can be associated with data generated from the user, such that data can be transferred without transferring protected health information. The pseudo-identifier can be one of a set of pseudo-identifiers, each pseudo-identifier in the set unique to a specific user identifier of a set of user identifiers for a population of users. As such, in variations, a set of pseudo-identifiers can be generated and assigned to specific patient populations (e.g., by condition, class of therapy, geographic region, etc.). Furthermore, the pseudo-identifier(s) is/are preferably generated at a first processor; however, the pseudo-identifier(s) can additionally or alternatively be generated in any other suitable manner.

Preferably, the pseudo-identifier in Block S310 is a unique character string, and preferably, the pseudo-identifier is randomly generated for the user. However, the pseudo-identifier can be generated in any other suitable manner. In one variation, the pseudo-identifier is a unique activation code that can be provided to the user and input by the user, when prompted, during installation of a native application by the user (e.g., as in Block S330). In this variation, extrapolated to a population of users, the activation code can be one of a set of activation codes, each activation code in the set unique to a specific intended user, such that set of pseudo-identifiers can be generated and assigned to specific patient populations (e.g., by condition, class of therapy, geographic region, etc.). In another variation, the pseudo-identifier is a uniform resource locator (URL) that comprises a reference to a resource (e.g., a link to a web page, a link to an application downloader on an application store) that facilitates installation of a native application by the user (e.g., as in Block S330). In a specific example of this variation, the pseudo-identifier is a unique URL (i.e., user-specific URL) that provides a link to an application store that facilitates an installation of a native application on a mobile device of the user. However, other variations of the pseudo-identifier can comprise any other suitable user-specific signature (e.g., image signature, audio signature) that serves as an abstraction of the user identifier associated with personal/protected information.

In Block S310, the network is preferably a network organizing sensitive user information such that the user identifier is associated with sensitive information (e.g., information subject to information sharing regulations). In one variation, the user identifier of the network is associated with PHI, including at least one of medical records, health status, provision of health care, and payment of health care associated with the user. In a specific example of this variation, the user identifier is a user identifier in a pharmacy patient network, and is associated with pharmacy records including medications of the user, insurance information of the user, and medication payments of the user. In this specific example, Block S310 is implemented by an application developer, and Block S310 facilitates data sharing between the application developer and a second entity distributing medications to the user. In another specific example of this variation, the user identifier is a user identifier in a hospital patient network, and is associated with medical records including immunizations, health status, medications, patient history, insurance information, and payment of health care. In this specific example, Block S310 is implemented by an application developer, and Block S310 facilitates data sharing between the application developer and a second entity providing health care to the user. In other variations, the network and user identifier can be any other suitable network/user identifier characterized by sensitive information that is subject to information sharing regulations (e.g., Heath Insurance Portability and Accountability Act of 1996 regulations).

Block S320 recites: generating an invitation including a tag associated with the pseudo-identifier, and functions to provide a means for promoting an application to the user, in a manner that allows an installation of a native application to be associated with the user. The invitation can comprise a message that provides an activation code as the pseudo-identifier to the user, as described with regard to Block S310 above. The activation code can then be input by the user, when prompted, during installation of a native application by the user. The invitation can additionally or alternatively comprise a message that provides a tag coupled to unique URL as the pseudo-identifier to the user, as described with regard to Block S310 above. As such, in some variations the tag can be selectable by the user, and in one variation, comprises a hyperlink to the unique URL that can be selected by the user (e.g., by touch screen, by voice command, by mouse click, etc.). Preferably, the invitation is electronic, and in variations, comprises at least one of an email message, a text message, and a voice message accessible by a message client executing on an electronic device (e.g., mobile device, personal computer, laptop computer, etc.) of the user. Alternatively, the invitation is non-electronic, and in variations, comprises a physical invitation (e.g., paper invitation) including a tag associated with the pseudo-identifier.

In Block S320, the invitation can be generated automatically upon inductance of the user into the network and/or can be generated manually based upon any suitable triggering event. In one example, receipt of a new patient (i.e., the user) into a pharmacy patient network (i.e., the triggering event) results in automatic generation of the invitation. In another example, a directive (i.e., the triggering event) by a pharmacist or other health care provider for a patient (i.e., the user) results in automatic or manual generation of the invitation. In yet another example, a directive (i.e., the triggering event) by a patient (i.e., the user) or a caretaker for the patient results in automatic or manual generation of the invitation. In other variations, however, the invitation in Block S320 can be generated in any other suitable manner based upon any other suitable triggering event.

Block S330 recites: providing the invitation to a user associated with the user identifier, wherein the invitation facilitates installation of a native application on a device of the user. Block S330 functions to convey the invitation to the user, thus prompting the user to install the native application. Providing the invitation to the user in Block S330 can comprise providing the invitation to the user electronically and/or non-electronically. In one example, providing the invitation comprises providing the invitation electronically by way of a text message accessible by a message client executing on an electronic device (e.g., mobile device, personal computer, laptop computer, etc.) of the user. In another example, providing the invitation comprises providing the invitation electronically by way of an email message accessible by an email client executing on an electronic device (e.g., mobile device, personal computer, laptop computer, etc.) of the user. In yet another example providing the invitation comprises providing a physical invitation to the user (e.g., a paper message mailed to the user). In still another example, providing the invitation comprises verbally providing an invitation to the user. Similar to Block S320, Block S330 can comprise providing the invitation automatically and/or manually, and can comprise providing the invitation based upon any suitable triggering event by any suitable entity (e.g., user, care provider, caretaker, etc.).

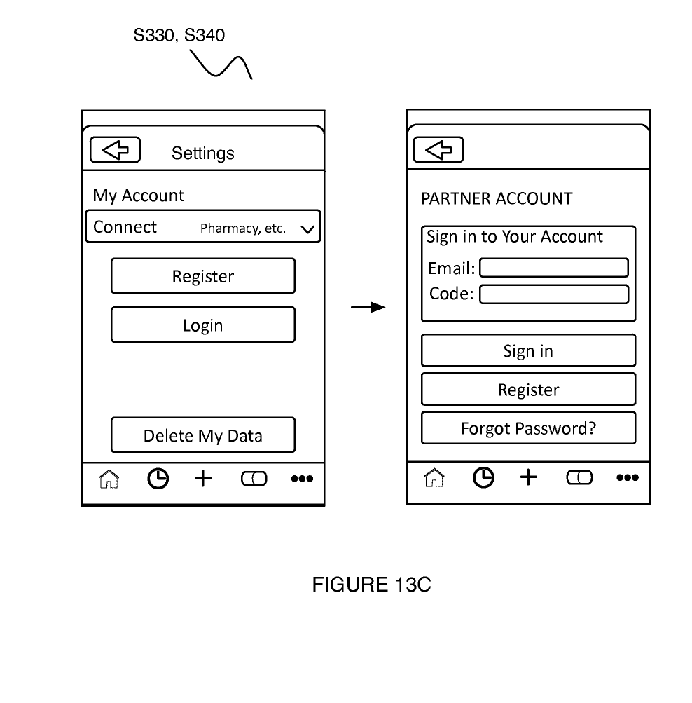

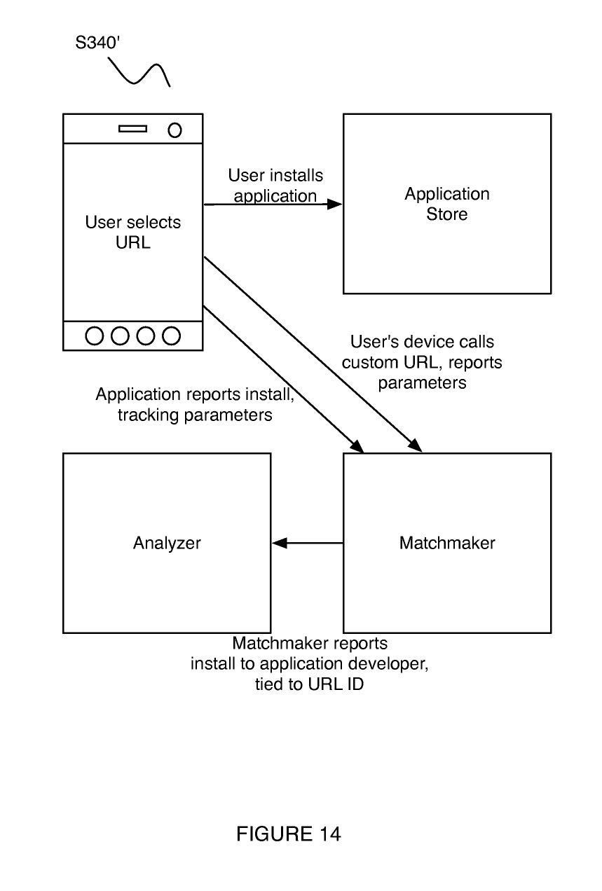

Block S340 recites: upon verification of the tag provided at the native application on the device of the user, associating the pseudo-identifier with the native application. Block S340 functions to establish a link between the native application (including interactions between the user and the native application) and the pseudo-identifier for the user, such that data generated from the user can be shared without sharing sensitive information (e.g., PHI). In one variation, Block S340 can comprise allowing the user to input a unique activation code (i.e., the pseudo-identifier), when prompted, during installation or activation of the native application at a device of the user (e.g., a mobile device of the user), as shown in FIGS. 13A and 13B. In another variation, as shown in FIG. 14, Block S340′ can comprise allowing the user to select the tag associated with the pseudo-identifier (e.g., by selecting a link in the invitation to a unique URL), which allows a tracker (e.g., cookie, set of parameters associated with the user's device and/or installation), uniquely associated with the user, to be transmitted to a matchmaking module (i.e., module configured to match the tracker to the native application and/or device of the user). Additionally in any of these variations, as shown in FIG. 13A-14, upon installation of the native application, verification of the tag, or at any other suitable point before, during, and/or after installation of the native application, the native application is preferably configured to report occurrence or initiation of the installation and the tracker to the matchmaking module, thus verifying the installation and the tracker associated with the user. Subsequently in any of these variations, the matchmaking module is configured to report occurrence of the installation to a developer of the application (i.e., installed as a native application on the user's device) in a manner that associates the occurrence of the installation of the native application with the pseudo-identifier of the user.

In a first example of this variation of Block S340, upon installation of the native application on the device of the user, a browser cookie (i.e., the tracker) is set in a browser of the user's device. Then, upon launching the native application by the user, the browser loads to find a browser cookie match, thus establishing an association between the pseudo-identifier of the user and the native application of the user. In a second example of this variation of Block S340, upon installation of the native application on the device of the user, a set of parameters (i.e., the tracker) associated with the user's device is transmitted to a matchmaking module. Then, in the second example, upon launch of the native application, the native application is configured to report occurrence of the installation and the set of parameters to the matchmaking module. The set of parameters in the second example comprises any one or more of: a timestamp, a user agent, an HTTP header, an operating system version, a default browser, a serial number, and any other suitable parameter that can be matched algorithmically to establish an association between the pseudo-identifier and the native application. Other variations and examples of Block S340 can, however, comprise any other suitable method of associating the pseudo-identifier with the native application based upon any other suitable tracker.

In some variations, Blocks S330 and S340 can thus enable a user who installs the native application, using the invitation/pseudo-identifier, to access information from an entity providing the invitation to install the native application. In variations, as shown in FIGS. 13A and 13C, the information can include medication lists from a clinical partner of the application developer. Additionally or alternatively, Block S340 can enable a user who installs the native application, using the invitation/pseudo-identifier, to access services provided by an entity providing the invitation to install the native application. In variations, as shown in FIGS. 13A and 13C, the services can include refilling prescriptions, renewing prescriptions, and automatic pre-population of the native application with information specific to the user (e.g., information regarding therapeutic substances for consumption by the user, information regarding a therapeutic substance regimen for consumption of a therapeutic substance, etc.).

Block S350 recites: receiving a set of data, generated from a set of interactions between the user and the native application and associated with the pseudo-identifier, and functions to establish transfer of data generated from the user in a manner that does not involve exchange of sensitive information (e.g., PHI). Block S350 can comprise receiving a set of data related to application usage by the user (e.g., application usage statistics, application usage behavior, etc), and can additionally or alternatively comprise receiving a set of data associated with any other interaction between the user and the native application. The set of data can be directly received from at least one of the native application and an application developer, or can be indirectly received (e.g., from a storage module). In a specific example, the set of data can comprise any one or more of: information pertaining to a therapeutic substance of the user (e.g., therapeutic substance name, active ingredient(s), strength, category, use, form, quantity, expiration date, medication provider information, etc.), therapeutic substance regimen information (e.g., dosage instructions, frequency instructions, time of usage instructions, usage risks, etc.), and information pertaining to adherence by the user to a medication regimen (e.g., based upon an adherence metric generated in response to the user's interactions with the native application). In other variations and examples of Block S350, receiving the set of data can include receiving any other suitable set of data generated from the user, by another suitable method.

Block S360 recites: in response to receiving the set of data, associating the set of data with the user identifier through the pseudo-identifier, and functions to map the set of data generated from the user to the user identifier, by means of the pseudo-identifier. Block S360 can additionally function to enable the set of data to be used by a second entity (e.g., a second entity receiving the set of data) to provide a targeted delivery to the user based upon the set of data characterizing the user's interactions with the native application. Block S360 can include implementing a matching algorithm configured to map the set of data associated with the pseudo-identifier, to the user identifier associated with sensitive information of the user. As such the set of data is mapped to the user identifier at the second entity, without transferring sensitive information (e.g., PHI) between the second entity and any other entity. Block S360 can, however, include any other suitable method of associating the set of data with the user identifier, without the transference of any sensitive user information.

Block S370 recites: generating an analysis of the set of data, and functions to transform the set of data generated from the user into an analysis that can be used to provide a targeted delivery to the user. Generating an analysis preferably includes generating an analysis of the usage of the native application by the user, and can comprise generating a metric that quantifies some aspect of the application usage by the user. In a first example, the analysis can comprise generation of a metric characterizing user's adherence to a medication regimen being provided at the native application. In a second example, the analysis can identify a characteristic or medical status of the user based upon the user's medication(s) and/or the user's behavior. In the second example, the analysis can identify a user as on the verge of being diabetic based upon an analysis taking into account the user's medications for managing pre-diabetes, and the user's lack of adherence to his/her pre-diabetes medication regimen. In a third example, generating an analysis can include determining a remaining quantity of a user's medication, based upon his/her interactions with the native application. Other variations of Block S370 can comprise generating any other suitable analysis of the set of data, in order to provide a targeted delivery to the user in Block S380.

Block S380 recites: providing a delivery to the user, based upon the analysis of the set of data, and functions to provide reinforcement of the user's usage of the native application and/or to simultaneously benefit the user and a second entity associated with the user by facilitating a financial transaction between the user and the second entity. Providing a delivery in Block S380 can comprise providing a reward to the user based upon the analysis, and functions to positively reinforce usage of the native application by the user. Preferably, the user is qualified for a reward based upon a comparison between the analysis and a threshold condition, an embodiment of which is described in relation to Block S160 above. The reward preferably has monetary value; however, the reward can alternatively have no monetary value. In a first example, the reward is a coupon that can be used to purchase an item (e.g., a low sugar product) from a second entity at a discounted price, wherein the item is configured to positively benefit the user (e.g., a pre-diabetic user) based upon the analysis of the set of data from the user. However, the reward can be delivered based upon any other suitable condition and/or native application usage behavior by the user.

Providing a delivery in Block S380 can additionally or alternatively comprise providing a notification to the user, based upon the analysis, which functions to provide at least one of an alert, a recommendation, and a notification to the user based upon the analysis of the user's usage of the native application. Embodiments of providing a notification to the user are described in relation to Block S170 above. In a first example, with regard to a provided reward, the notification can include an alert notifying the user that he/she has received a reward. In a second example, the notification can include a recommendation to refill a medication prescription based upon the user's adherence to a medication regimen provided at the native application of the user. The notification is preferably transmitted over a message client configured to generate a notification at a user interface of the application executing on the user's device, via email, via text message, via voicemail, and/or via a social network (e.g., Facebook, Twitter) message. The notification can alternatively be transmitted using any other suitable method, and furthermore, any other suitable notification relevant to the user can be provided based upon the analysis generated in Block S370.

Providing a delivery in Block S380 can additionally or alternatively comprise providing an advertisement to the user based upon the analysis, which functions to provide advertising tailored to the user based a characteristic of the user, as determined from the analysis. Embodiments of providing an advertisement to the user are described in relation to Block S180 above. In one example, providing an advertisement comprises providing to an advertisement to the user based upon an analysis of medications the user is taking and/or is not taking as part of a medication regimen. In this example, the advertisement is for a product that is beneficial to the user's health, based upon the analysis, and is vended by the second entity. Providing an advertisement can, however, include providing an advertisement for any suitable product or service based upon an analysis of the user's usage of the native application.

The method 300 for enrolling and mapping users can further comprise any other suitable Block(s) or Step(s), based upon the function of the method 300 and/or the native application executing on a device of the user. In one variation, the native application can be automatically filled with therapeutic substance regimen information, medication information, and/or supplement information, upon installation of the native application at an electronic device of the user (e.g., mobile device of the user). This specific example further allows aggregation of information related not only prescription medications, but also OTC medications, supplements, and/or any other therapeutic substance. In another variation for a native application configured to facilitate user adherence to a medication regimen the method 300 can further comprise automatically refilling or renewing a medication prescription based upon the analysis S390. Block S390 functions to automatically refill or renew a medication for a user in order to support adherence to a medication regimen by the user using the native application. In variations of the method 100 comprising Block S390, Block S370 can include generating an analysis that tracks a remaining amount of a medication of the user, and Block S390 can include automatically refilling or renewing the prescription when the remaining amount drops below a specified threshold. Automatically renewing a medication is similar to automatically refilling a medication; however, more time is typically needed to renew medication prescriptions due to a requirement for authorization by a medical professional servicing the user. However, the specified threshold associated with renewing a medication is preferably greater than that associated with refilling a medication to account for additional time required to renew medication prescriptions.

Additionally, as shown in FIG. 12, the method 100 can be extrapolated to a set of users (e.g., a population of users associated with the second entity, a set of users of a given demographic), such that multiple users can receive pseudo-identifiers that facilitate transfer of data generated from the set of users to a second entity, without transferring sensitive information (e.g., PHI). In variations of the method 300 adapted to multiple users, Block S310 can include: for each user in a set of users, generating a unique pseudo-identifier for a user identifier characterized by an associated set of personal information, thus generating a set of unique pseudo-identifiers. Similarly, Blocks S320 and S330 can include: for each user in the set of users, generating an invitation comprising a tag associated with the unique pseudo-identifier of the set of unique pseudo-identifiers, and providing the invitation to the user of the set of users, wherein the invitation facilitates installation of a native application on a device of the user. Block S340 can include: for each user in the set of users, upon installation of the native application on the device of the user of the set of users, associating the unique pseudo-identifier of the user with the native application installed on the device of the user. Block S350 can include: for each user in the set of users, receiving a set of data, generated from a set of interactions between the user and the native application and associated with the unique pseudo-identifier. Block S360 can include: for each user in the set of users, associating the set of data from the user with the user identifier though the unique pseudo-identifier. Blocks S370 and S380 can include: for each user of the set of users, generating an analysis of the set of data and providing a delivery to the user of the set of users, based upon the analysis of the set of data of the user. As such, the method 300 adapted to incorporate a set of users can be used to transfer data generated from the set of users (e.g., application usage data from a cohort of users enrolled in application, wherein the cohort is of interest to a second entity), without transferring sensitive information (e.g., PHI) from the set of users.

In order to provide flexibility in relationships with partners in sharing user data, some embodiments of the methods 100, 300 can entirely omit one or more of Blocks S310 through S390. Furthermore, as a person skilled in the art will recognize from the previous detailed description and from the figures and claims, modifications and changes can be made to the preferred embodiments of the methods 100, 300 without departing from the scope of the methods 100, 300.

### 2. System

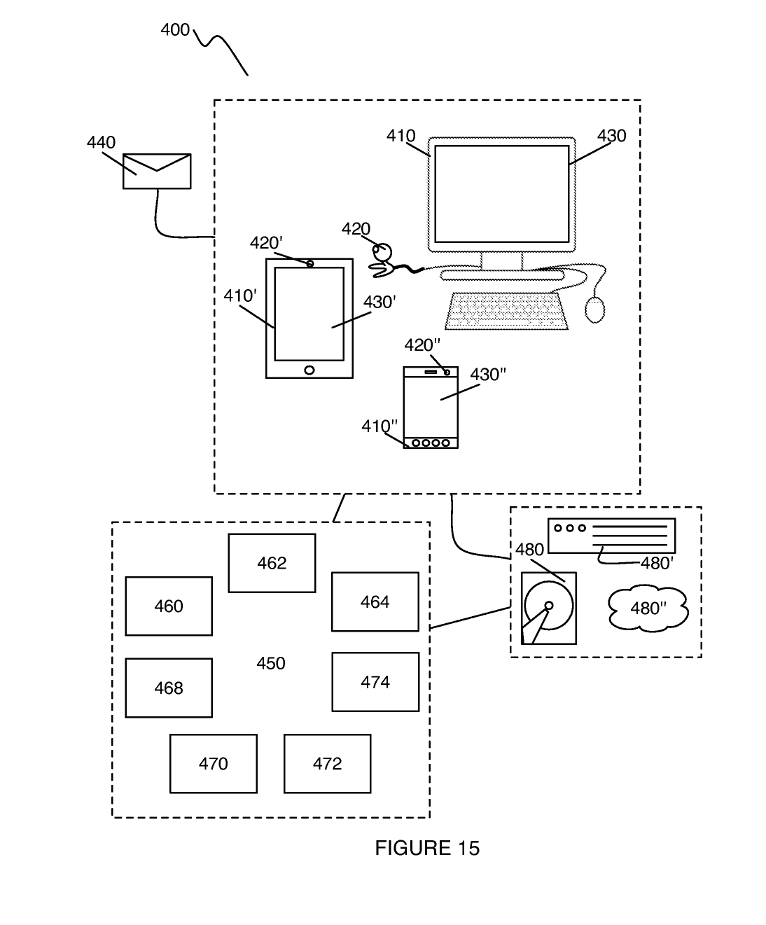

As shown in FIG. 15, a system 400 for managing a medication regimen comprises a computing device 410 coupled to an imaging module 420, a user interface 430, and a message client 440; and a processor 450 comprising a first module 460 configured to receive therapeutic substance information from a user with the imaging module 420, a second module 462 configured to receive information about a regimen from the user at the user interface 430, a third module 464 configured to provide interaction information based on the medication information and/or supplement information, a fourth module 468 configured to receive an ascertainment of adherence to the regimen at a set of time points, a fifth module 470 configured to generate a value of an adherence metric based on the ascertainment to the regimen and the set of time points, a sixth module 472 configured to provide a reward to the user based upon the value of the adherence metric, and a seventh module 474 configured to provide an automated notification to the user at the message client 440. The processor 450 of the system 300 can further comprise a storage module 480 coupled to the computing device 410 and the processor 450, and at least one additional module configured to provide an advertisement to the user based on at least one of the medication information, the supplement information, and the regimen, to generate a comparison of the value of the adherence metric for the user to a second value of the adherence metric generated based on data for at least a second user, to generate an automated refill request based on at least one of the medication information, the supplement information, and the regimen, and/or to generate an automated renewal request based on at least one of the medication information, the supplement information, and the regimen. An embodiment of the system 400 can be configured to perform the method 100 described above, and variations of the system 400 can be configured to perform variations of the method 100 described above.

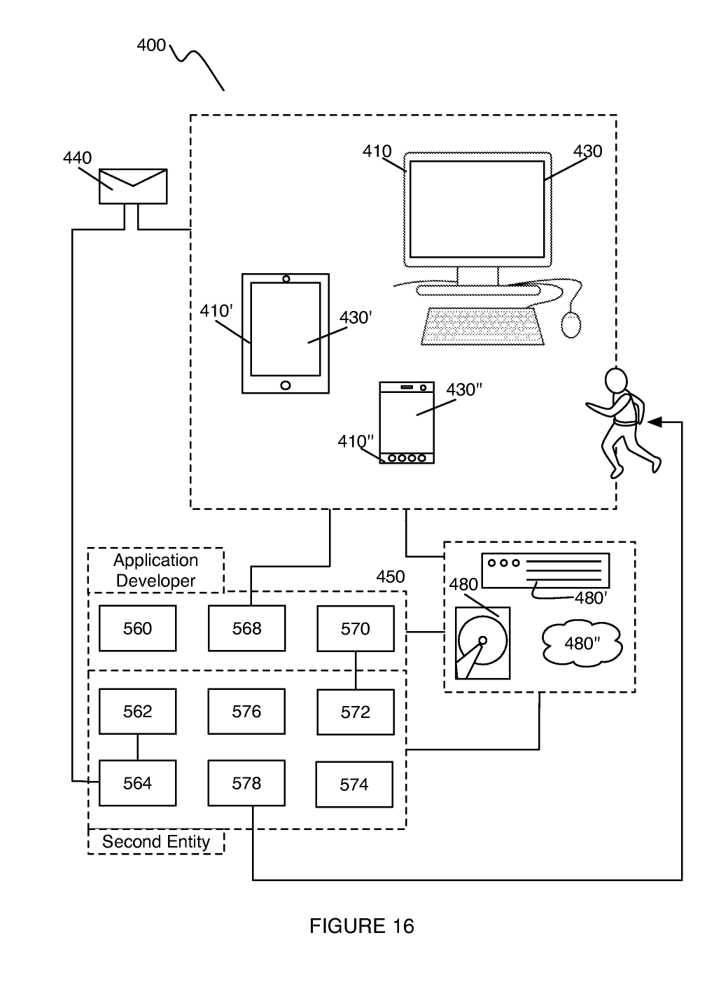

In some variations, the system 400 can additionally or alternatively be configured to implement at least a portion of the method 300 for enrolling and mapping users described above. As such, as shown in FIG. 16, the processor 450 can additionally or alternatively include first subsystem 560 configured to generate a pseudo-identifier for a user identifier within a network, wherein the user identifier is characterized by an associated set of personal records, a second subsystem 562 configured to generate an invitation comprising a tag associated with the pseudo-identifier, a third subsystem 564 configured to send the invitation to a user associated with the user identifier, wherein the invitation facilitates installation of a native application on a device of the user, a fourth subsystem 568 configured to associate the pseudo-identifier with the native application upon installation of the native application on the device of the user, a fifth subsystem 570 configured to transmit a set of data, generated from a set of interactions between the user and the native application and associated with the pseudo-identifier, a sixth subsystem 572 configured to receive a set of data, generated from a set of interactions between the user and the native application and associated with the pseudo-identifier, a seventh subsystem 574 configured to associate the set of data with the user identifier through the pseudo-identifier in response to receiving the set of data, an eighth subsystem 576 configured to generate an analysis of the set of data, and a ninth subsystem 578 configured to provide a delivery to the user, based upon the analysis of the set of data. The system 400 can, however, include any other suitable element(s) configured to facilitate enrolling and mapping users in any other suitable manner.

The method 100 and/or system 400 of the preferred embodiment and variations thereof can be embodied and/or implemented at least in part as a machine configured to receive a computer-readable medium storing computer-readable instructions. The instructions are preferably executed by computer-executable components preferably integrated with the system 400 and one or more portions of the processor 350. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

The FIGURES illustrate the architecture, functionality and operation of possible implementations of methods according to preferred embodiments, example configurations, and variations thereof. In this regard, each block in the flowchart or block diagrams may represent a module, segment, or portion of code, which comprises one or more executable instructions for implementing the specified logical function(s). It should also be noted that, in some alternative implementations, the functions noted in the block can occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As a person skilled in the art will recognize from the previous detailed description and from the figures and claims, modifications and changes can be made to the preferred embodiments of the invention without departing from the scope of this invention defined in the following claims.

We claim:

1. A method for managing therapeutic substance usage by a user, comprising:
receiving therapeutic substance information pertaining to a set of therapeutic substances, from the user at a user interface;
generating an interaction analysis between a first therapeutic substance and a second therapeutic substance of the set of therapeutic substances;
receiving information regarding a therapeutic substance regimen for consumption of the set of therapeutic substances, at the user interface;
receiving an ascertainment of adherence to the therapeutic substance regimen by the user at a set of time points, at the user interface, wherein receiving the ascertainment includes providing an imaging module, configured to acquire image data of at least one of the set of therapeutic substances, to the user;
automatically generating a request for at least one of a refill and a renewal of one of the set of therapeutic substances, based upon the ascertainment of adherence and the set of time points;
generating a value of an adherence metric based upon the ascertainment of adherence and the set of time points;
providing a reward to the user based upon the value of the adherence metric;
generating a second value of the adherence metric based upon information for at least one other user;
generating a comparison between the value and the second value of the adherence metric;
providing an automated notification to the user pertaining to at least one of the interaction analysis, the request, the value of the adherence metric, the reward, and the comparison; and
automatically providing an advertisement to the user based upon at least one of the therapeutic substance information and the reward.

2. The method of claim 1, wherein generating the second value of the adherence metric includes generating the second value of the adherence metric based upon data from a second user consuming a second set of therapeutic substances, wherein the second set of therapeutic substances is not identical to the set of therapeutic substances.

3. The method of claim 1, wherein providing an automated notification includes providing a notification at least at one of a message client and a display of a mobile device of the user.

4. The method of claim 1, wherein receiving the therapeutic substance information includes receiving an image dataset of at least one of the set of therapeutic substances from the imaging module, and extracting a portion of the therapeutic substance information from the image dataset based upon a detection algorithm.

5. A method for managing therapeutic substance usage by a user and promoting a behavior change of the user, the method comprising:
receiving therapeutic substance information pertaining to a therapeutic substance, from the user at a user interface;
receiving information regarding a therapeutic substance regimen for consumption of the therapeutic substance;
receiving an ascertainment of adherence to the therapeutic substance regimen by the user at a set of time points, at the user interface;
generating a value of an adherence metric based upon the ascertainment of adherence to the therapeutic substance regimen and the set of time points;
providing a reward to the user based upon the value of the adherence metric;
generating a second value of the adherence metric based upon information for at least one other user;
generating a comparison between the value and the second value of the adherence metric; and
providing an automated notification to the user pertaining to at least one of the value of the adherence metric, the reward, and the comparison, thereby promoting the behavior change of the user.

6. The method of claim 5, wherein receiving information regarding the therapeutic substance regimen includes receiving information from at least one of the user at a user input device coupled to the user interface, and a healthcare provider administrating the therapeutic substance to the user.

7. The method of claim 5, wherein receiving the ascertainment of adherence to the therapeutic substance regimen includes providing a set of instructions to the user upon detection that the user has missed a dose of the therapeutic substance.

8. The method of claim 5, further including providing an imaging module configured to acquire image data of the therapeutic substance, to the user, wherein at least one of receiving the therapeutic substance information and receiving an ascertainment of adherence to the therapeutic substance regimen includes receiving an image dataset of the therapeutic substance from the imaging module, and extracting a portion of the therapeutic substance information from the image dataset based upon a detection algorithm.

9. The method of claim 5, wherein generating the value of the adherence metric includes generating a first quantity characterizing correct adherence to the therapeutic substance regimen by the user, a second quantity characterizing incorrect adherence to the therapeutic substance regimen by the user, and a derivative value based upon the first quantity and the second quantity, and wherein generating the second value of the adherence metric includes generating an aggregate version of the derivative value, derived from a population of users.

10. The method of claim 9, wherein generating the comparison includes rendering a graphic representing the derivative value for the user, and a second graphic representing the aggregate version of the derivative value at a display of the user interface.

11. The method of claim 5, further including automatically providing an advertisement to the user based upon at least one of the therapeutic substance information and the reward.

12. The method of claim 11, further including receiving a supplementary dataset, including a substantially real-time location of the user, wherein providing the advertisement to the user includes providing the advertisement for a vendor in proximity to the user, based upon the therapeutic substance information and the substantially real-time location of the user.

13. A method for managing therapeutic substance usage by a user, comprising:
receiving therapeutic substance information pertaining to a set of therapeutic substances, from the user at a user interface;
generating an interaction analysis between a first therapeutic substance and a second therapeutic substance of the set of therapeutic substances;
receiving information regarding a therapeutic substance regimen for consumption of the set of therapeutic substances;
receiving an ascertainment of adherence to the therapeutic substance regimen by the user at a set of time points, at the user interface;
automatically generating a request for at least one of a refill and a renewal of one of the set of therapeutic substances, based upon the ascertainment of adherence and the set of time points;
generating a value of an adherence metric based upon the ascertainment of adherence and the set of time points;
providing a reward to the user based upon the value of the adherence metric;
providing an automated notification to the user pertaining to at least one of the interaction analysis, the request, the value of the adherence metric, and the reward.

14. The method of claim 13, wherein at least one of receiving therapeutic substance information pertaining to a set of therapeutic substances and receiving information regarding the therapeutic substance regimen includes: receiving information from a healthcare provider administrating one of the set of therapeutic substances to the user.

15. The method of claim 13, wherein automatically generating the request includes generating an estimated time at which the user will fully exhaust a therapeutic substance of the set of therapeutic substance, based upon a determined quantity of the therapeutic substance and the ascertainment; automatically notifying a therapeutic substance provider of the request prior to the estimated time; and receiving notification from the therapeutic substance provider upon fulfillment of the request.

16. The method of claim 15, wherein receiving the ascertainment of adherence to the therapeutic substance regimen includes providing a set of instructions to the user upon detection that the user has missed a dose of at least one of the set of therapeutic substances.

17. The method of claim 13, wherein generating the value of the adherence metric includes generating a first quantity characterizing correct adherence to the therapeutic substance regimen by the user, a second quantity characterizing incorrect adherence to the therapeutic substance regimen by the user, and a derivative value based upon the first quantity and the second quantity, and wherein the method further includes: generating an aggregate version of the derivative value, derived from a population of users; and providing the derivative value and the aggregate version of the derivative value to the user at the user interface.

18. The method of claim 13, further including providing an imaging module configured to acquire image data of at least one of the set of therapeutic substances, to the user, wherein at least one of receiving the therapeutic substance information and receiving an ascertainment of adherence to the therapeutic substance regimen includes receiving an image dataset of at least one of the set of therapeutic substances from the imaging module, and extracting a portion of the therapeutic substance information from the image dataset based upon a detection algorithm.

19. The method of claim 13, further including automatically providing an advertisement to the user based upon at least one of the therapeutic substance information and the reward.

20. The method of claim 19, further including receiving a supplementary dataset, including a substantially real-time location of the user, wherein providing the advertisement to the user includes providing the advertisement for a vendor in proximity to the user, based upon the therapeutic substance information and the substantially real-time location of the user.
